(19) United States
(12) Patent Application Publication
(10) Pub. No.: US 2015/0121238 A1
(43) Pub. Date: Apr. 30, 2015

(54) REMOTE PLAY SYSTEM

(71) Applicants: Streaming21 International Inc., San Jose, CA (US); Quanta Computer Inc., Tao Yuan Shien (TW)

(72) Inventors: Jung-Shen LEE, Hsinchu City (TW); Meng-Jou LIN, New Taipei City (TW); Chun-Chieh PENG, Taipei City (TW); Po-Sheng HUANG, New Taipei City (TW); I-Chi CHEN, New Taipei City (TW)

(73) Assignees: STREAMING21 INTERNATIONAL INC., San Jose, CA (US); QUANTA COMPUTER INC., Tao Yuan Shien (TW)

(21) Appl. No.: 14/244,110

(22) Filed: Apr. 3, 2014

(30) Foreign Application Priority Data
Oct. 28, 2013 (TW) 102138917

(51) Int. Cl. H04L 29/08; G06F 3/0481; G06F 3/0488; G06F 3/0486

(52) U.S. Cl. CPC H04L 67/06; G06F 3/0486; G06F 3/04817; H04L 67/02; G06F 3/04883
USPC 715/738

(57) ABSTRACT

A remote play system includes: at least a remote device and a master device wireless coupled to the remote device. The master device includes a touch screen. A browser panel on the touch screen of the master device displays a remote device display region displaying at least a remote device icon which represents the remote device. The browser panel on the touch screen of the master device further displays a file display region displaying at least a file icon which represents a to-be-shared file. In response to a drag-and-drop event triggered on the touch screen, the file icon is dragged and dropped to the remote device icon, and the master device shares the file to the remote device.

This application claims the benefit of Taiwan application Serial No. 102138917, filed Oct. 28, 2013, the subject matter of which is incorporated herein by reference.

### TECHNICAL FIELD

The disclosure relates in general to a remote play system.

### BACKGROUND

Along with the development in electronic products and network communication, more and more electronic products, such as notebook computers, tablet PCs and smart phones, support network communication function. Through network, the electronic device may transmit/receive information to/from other electronic devices.

To meet the requirements of the market, electronic products matching users' usage habits (such sharing pictures and files) and having user friendly interface of operation are needed.

### SUMMARY OF THE DISCLOSURE

The disclosure is directed to a remote play system. The user shares a file to a remote device by way of dragging and dropping on a remote play program of a master device.

According to one embodiment of the present disclosure, a remote play system comprising at least a remote device and a master device is provided. The master device is wirelessly coupled to the remote device, and comprises a touch screen. At least a remote device icon representing the remote device is displayed on a remote device display region of a browser panel of the touch screen. At least a file icon representing a to-be-shared file is displayed on the file display region of the browser panel of the touch screen. In response to a drag-and-drop event triggered on the touch screen, the file icon is dragged and dropped to the remote device icon, so that the master device shares the file to the remote device.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 is a system architecture diagram of a remote play system according to an embodiment of the present disclosure.

FIG. 2 is a schematic diagram of a browser panel of a master device according to an embodiment of the present disclosure.

FIG. 3 is a schematic diagram of a control panel of a master device according to an embodiment of the present disclosure.

FIGS. 4A to FIG. 4D are scenarios of remote play according to an embodiment of the present disclosure.

FIG. 5 is a scenario of adding/removing a control panel and screen switching according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION OF THE DISCLOSURE

Technical terms used in the specification are reference to generally-known terminologies used in the technology field. For any terms described or defined in the specification, the descriptions and definitions in the specification shall prevail. For common technologies and theories which do not involve the technical features of the present disclosure, the details are omitted. In addition, the shapes, sizes and scales of elements are schematically shown in the drawings for anyone who is skilled in the technology field of the present disclosure to understand the present disclosure, not for limiting the scope of implementation of the present disclosure.

The embodiment of the present disclosure has one or more technical characteristics. In implementation of the disclosure, anyone who is skilled in the technology field of the present disclosure may selectively implement or combine parts or all of the technical characteristics of any embodiment of the present disclosure.

An embodiment of the present disclosure is directed to the remote play between many electronic devices having network communication function, and a related user interface thereof.

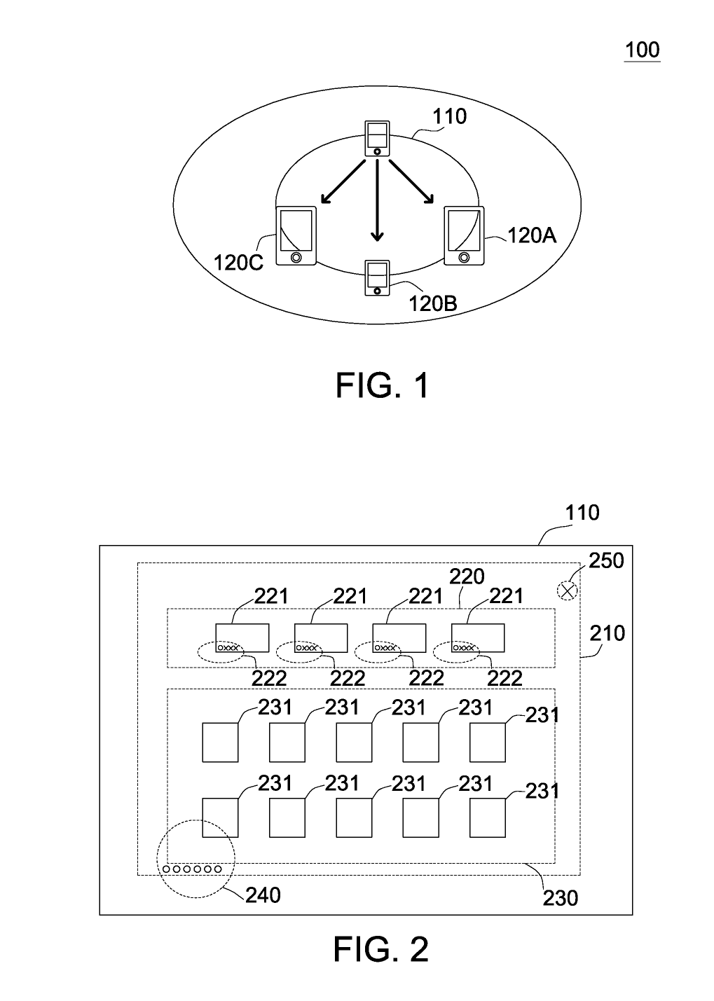

Referring to FIG. 1, a system architecture diagram of a remote play system 100 according to an embodiment of the present disclosure is shown.

The remote play system 100 includes a master device 110 and remote devices 120A˜120C. Although three remote devices are illustrated in FIG. 1, the embodiment of the present disclosure is not limited thereto. In the present embodiment, the quantity of the remote devices controlled by the master device 110 may be adjusted according to actual needs.

In the present disclosure, the term “remote play” refers to an event that a master device shares an object such as a file, a document, a photo, a film, or music to a remote device, wherein the object is played by the master device and the remote device. How the embodiment of the present disclosure achieves “remote play” is elaborated below. Exemplarily but not restrictively, the master device and the remote device are such as smart phones, notebook computers, and tablet PCs. The master device installs a remote play program. Or, any electronic device which installs a remote play program may be used as a master device.

In an embodiment of the present disclosure, the master device and the remote device both have network connection function. Exemplarily but not restrictively, the master device and the remote device may be coupled to a wireless network, a 3G network and so on. To put it in another way, a wireless connection is established between the master device and the remote device. In implementing the present embodiment, all devices (that is, the master device 110 and the remote devices 120A˜120C) of the remote play system 100 are automatically synchronized. Thus, the master device and the remote device recognize each other. The master device displays icons of all controllable remote devices, and the remote device displays icon of the master device. In an embodiment of the present disclosure, the device sharing a file to another device is referred as a master device, and the device receiving the shared file is referred as a remote device. Within the spirit of the embodiment of the present disclosure, the roles of the master device and the remote device are not fixed. That is, when a device A intends to share a file to devices B and C, the device A is a master device, and the devices B and C are remote devices. Afterwards, if the device B intends to share a file to the device A, the device B is a master device, and the device A becomes a remote device.

In an embodiment of the present disclosure, during file sharing or remote play, there are many modes, namely, playing/sharing one single file to one single remote device, playing/sharing many files to single remote device, playing/sharing single file to many remote devices (even to all remote devices), and playing/sharing many files to many remote devices (even to all remote devices).

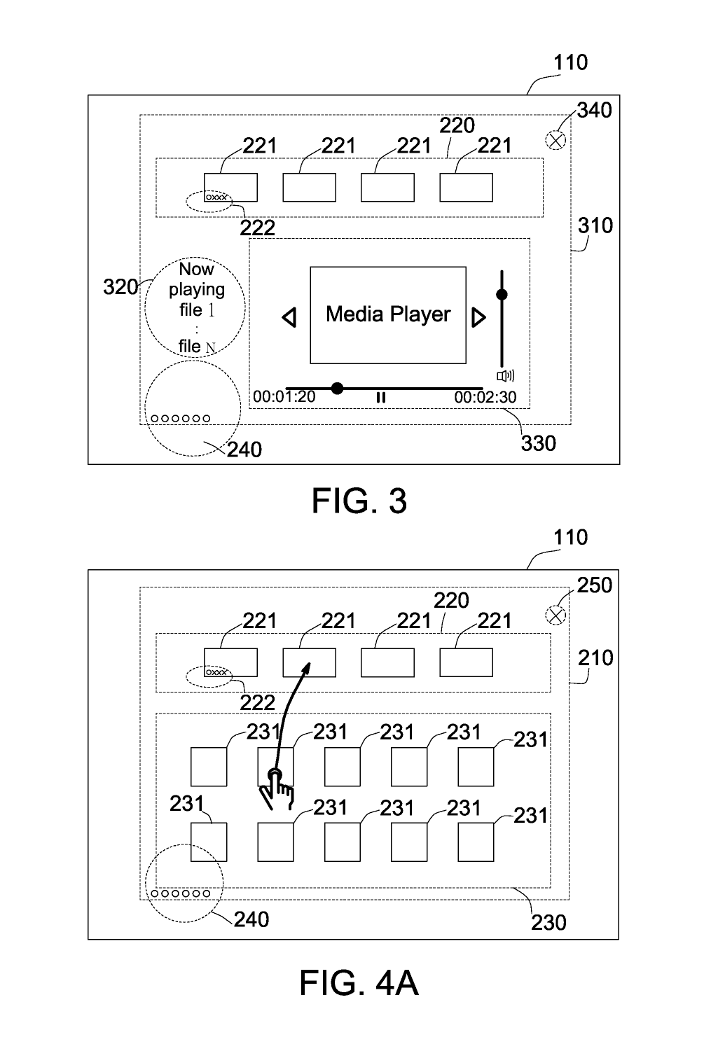

Referring to FIG. 2, a schematic diagram of a display interface of a master device according to an embodiment of the present disclosure is shown. Here, the display interface is referred as a browser panel, which is displayed on the screen of the master device when the user intends to share a file to the remote device. As indicated in FIG. 2, the browser panel 210 includes a remote device display region 220, a file display region 230, an indicating region 240 and an exit icon 250.

The remote device display region 220 displays icons of all remote devices controlled by the master device 110. The remote device display region 220 includes remote device display icons 221 each representing a remote device. When the master device shares one or more files to the remote device, the corresponding remote device display icon 221 of each remote device displays the file play progress of the remote device. That is, the user of the master device identifies the file play progress and situation of each remote device based on the remote device display icon 221.

The remote device display icon 221 selectively includes a mode display icon 222. The mode display icon 222 displays an accept mode of the remote device. In the present embodiment, the accept mode of the remote device includes at least four modes, namely, a prompt mode, an “accept once” mode, an “accept all” mode and a block mode. In the prompt mode, each time when the remote device receives the file that the master device intends to share, the remote device pops up a prompt message for the user of the remote device to decide whether to receive the file that the master device intends to share. In the “accept once” mode, the remote device may automatically grant to receive the file transmitted from the master device once. In the “accept all” mode, the remote device always automatically grants to receive the file from the master device. In the block mode, the remote device always blocks the file from the master device (that is, the user of the remote device does not want to receive the file transmitted from the master device). For the user of the master device to conveniently understand the accept mode of each remote device, the mode display icon 222 may use different colors to represent different accept modes. For example, green represents the “accept once” mode and/or the “accept all” mode, yellow represents the prompt mode, and red represents the block mode.

Based on the color of the mode display icon 222, the user of the master device identifies the accept mode of each remote device and conveniently decide whether to share to the remote device. For instance, the user of the master device will not try to share to a remote device marked in red (because the remote device is in the block mode).

The file display region 230 includes many file icons 231, each representing a to-be-shared file. The user may click on one or more file icons so as to conveniently share the file.

The indicating region 240 includes many indicator icons, wherein one indicator icon (such as the rightmost indicator icon) represents a browser panel, and other indicator icons represent control panels.

When the user clicks on the exit icon 250 of the browser panel 210, the master device exits the remote play program and terminates all remote play.

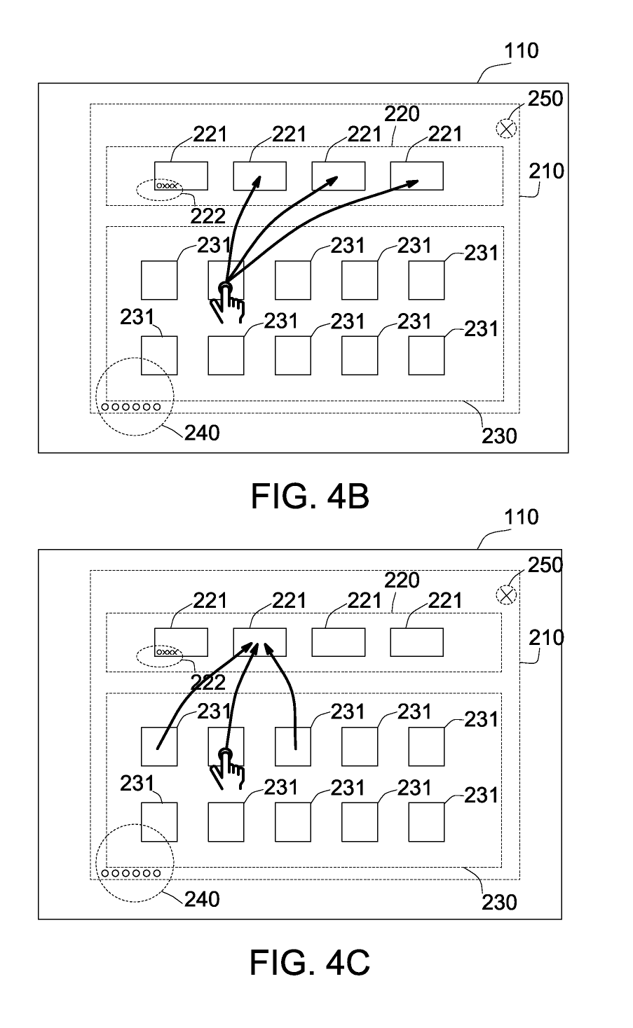

FIG. 3 is a schematic diagram of a control panel of a master device according to an embodiment of the present disclosure. The control panel 310 further includes a playlist 320, a play region 330 and an exit icon 340 in addition to the remote device display region 220 and the indicating region 240.

The playlist 320 may display file(s) shared from the master device . In default setting, the files displayed on the playlist 320 will be played in sequence. To make it easier for the user to understand, the currently played files may be marked in different colors.

The play region 330 displays the file play situation. The user of the master device may select an icon on the play region 330 to control file play situation. For instance, the user may pause file play, play a next or a previous file, control the volume or search for the play time of the file. The play region 330 may also display the current file play time.

After the user selects a to-be-shared file from the browser panel 310 and shares the file to the remote device, the screen displayed on the master device will change to the control panel 310 from the browser panel 210. Through the control panel 310, the user of the master device may control play of the shared file and understand the play situation of each remote device. In the browser panel 210 and the control panel 310, respective remote device display icon 221 on the remote device display region 220 displays current the file play situation (such as playing or pause) of respective remote device. Therefore, the user of the master device may identify the play progress and play situation of each remote device by watching each remote device display icon 221.

If the user of the master device trigger many events of remote play (the definition of remote play is disclosed below), then many control panels 310 may be generated on the master device. In the indicator icon of the indicating region 240, the indicator icon corresponding to the currently displayed control panel 310 may be shown in a different color.

The control panel 310 further includes the exit icon 340. When the user presses the exit icon 340 of the control panel 310, the system will jump to a browser panel or another control panel. In addition, the browser panel and the control panel may not include any exit icon (that is to say, in the embodiment of the disclosure, the exit icon is optional). Under such circumstance, the user may press the return key of the master device to exit the browser panel or exit the control panel.

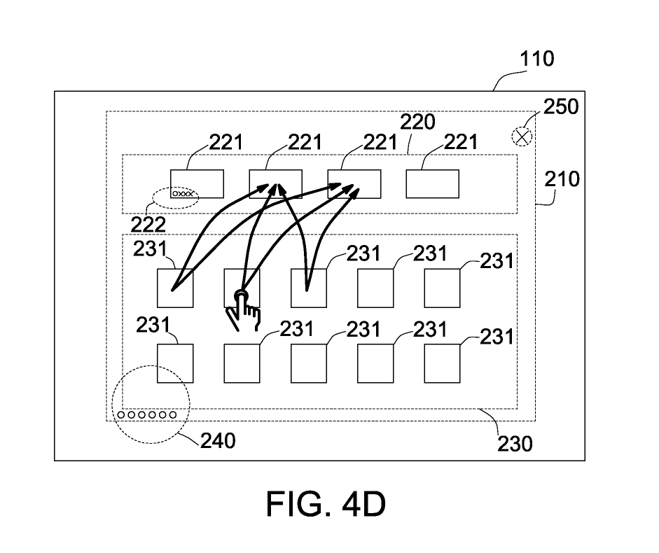

Referring to FIG. 4A to FIG. 4D, a number of scenarios of remote play of an embodiment of the present disclosure are elaborated.

As indicated in FIG. 4A, when the user intends to share one single file to one single remote device, the user may drag the to-be-shared file from a file display region 230 to the target remote device icon 221 of the remote device display region 220 for file sharing.

In an embodiment of the present disclosure, files may be transmitted between the master device and the remote device in data streaming, and the procedures are as follows. The master device sends a request for remote play to the remote device. If the remote device allows the request, then the remote device responds to the master device. When the master device receives the grant response from the remote device, the master device may divide the to-be-shared file into data streams. Then, the master device respectively transmits the data streams to the remote device. For the remote device, the received data streams may be stored in a buffer memory of the remote device. After enough amount of data streams is received (even though receiving of the file is not complete yet), the remote device may start to play the received data streams.

In an embodiment of the present disclosure, files are transmitted data streams. The advantage is that even when the remote device misses one or several data streams during the reception process due to external factors such as network connection problem, the play of the received file will not be affected if the content of the to-be-shared file is music or films or photos.

When the files are transmitted in the form of data streams, although the data streams are stored in the internal buffer memory of the remote device, after play, the shared file will not be permanently stored in the remote device. For the master device, although data are shared to a remote device, the master device still keeps privacy because the remote device does not permanently keep the shared file.

In an embodiment of the present disclosure, the scenarios of FIG. 4A˜FIG. 4D are referred as generation of sessions. That is, the scenarios of FIG. 4A˜FIG. 4D are referred as “generation of one or more sessions”. When one or more session is generated, one or more control panels 310 will be generated.

FIG. 4B shows the scenario that the user shares one single file to many remote devices (or even to all remote devices). FIG. 4C shows the scenario that the user shares many files to one single remote device. FIG. 4D shows the scenario that the user shares many files to many remote devices (or even to all remote devices). Details of the scenarios of FIG. 4B˜4D are similar to the scenario of FIG. 4A, and the similarities are not repeated here.

For the convenience of operation and display, if the user's operation is as indicated in FIG. 4B or FIG. 4D, then many control panels will be generated, and each control panel corresponds to a remote device. If the user's operation is as indicated in FIG. 4A or FIG. 4C, then one single control panel will be generated.

For example, if the user shares three files to four remote devices, then four control panels will be generated on the master device, and the four control panels respectively correspond to the four remote devices. The three files are displayed on the playlist of each control panel, and each remote device will play the three files in sequence.

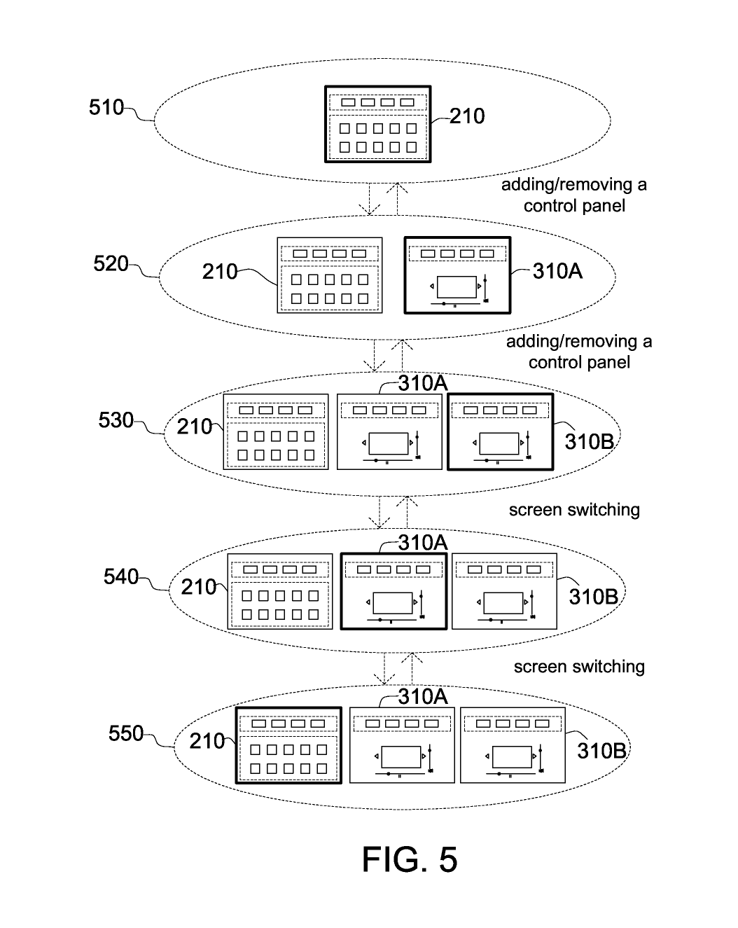

FIG. 5 is a scenario of adding/removing a control panel and screen switching according to an embodiment of the present disclosure. In the scenario 510, the browser panel 210 is displayed on the master device. If the user adds a control panel (that is, the user starts a remote play), as shown in the scenario 520, the master device displays a control panel 310A. Then, if the user adds a control panel again (that is, the user starts another remote play), as shown in the scenario 530, the master device displays a control panel 310B. Conversely, if the user exits the control panel, then the scenario changes to the scenario 520 from the scenario 530 or changes to the scenario 510 from the scenario 520.

Besides, the user may switch screens. For instance, in the scenario 530 (or 540), the user may wave a hand gesture (such as sliding to the left or sliding to the right) or press an indicator icon on the indicating region 240 to switch the screen for changing to the scenario 540 (or 550). In addition, the user may also press an indicator icon on the indicating region 240 to jump to its corresponding control panel or return to the browser panel.

Moreover, if the user adds a control panel, then an indicator icon is added to the indicating region 240. Conversely, if the user removes a control panel (that is, the user exits the control panel), then an indicator icon is removed from the indicating region 240. Besides, when an object (such as the user's finger) contacts the indicating region 240, the size of the indicator icon closest to the object will be changed (such as enlarged) for the convenience of the user's operation.

Two-way control (applicable to the scenario in which the master device shares one or more files to one single remote device) and one-way control (applicable to the scenario in which the master device shares to many remote devices) are disclosed in an embodiment of the present disclosure.

Under two-way control, the play progress of the master device and that of the single target remote device may be synchronized. In addition, the play progress of one of the master device and the single target remote device will be fed back to the other one so that the master device and the single target remote device may be synchronized on file playing. For instance, when the user of the master device pauses file play, the target remote device will also pause the file playing accordingly. Conversely, when the user of the remote device pauses file play, the file play on the master device will be paused accordingly. Or, when one of the master device and the single target remote device adjusts its volume or play position, the volume and play position of the other device will be adjusted accordingly.

Under one-way control, the control operation on the master device may control all target remote devices but the control operation on the remote device will not feed back to the master device. For instance, when the user of the master device pause file play, the file play on all target remote devices will be paused accordingly. Conversely, when the user of a remote device pauses file play, file play on the master device and on all other remote device will not be paused. However, file play situations on the remote device will be fed back to the master device, so that the file play progress displayed on a corresponding control panel of the master device and the file play progress on the remote device may be synchronized.

Moreover, the master device and the remote device may share an application program with each other. For instance, the master device may share an application package file (apk) to one or more remote devices. If the remote device agrees to receive the apk, then the remote device will automatically execute the apk, and the installation progress of the remote device will be displayed on the control panel of the master device.

In an embodiment of the present disclosure, in terms of the operation of the master device, when the user intends to share to a remote device, the user of the master device may conveniently share to the remote device by way of drag and drop file(s) on the touch screen of the master device, and such sharing process is very convenient.

The user of the remote device may keep his/her privacy by setting the accept mode. That is, when the user of the remote device sets the accept mode as “block mode”, all files transmitted from the master device will be blocked and the user will be free of interference.

The embodiments of the present disclosure may be used in many environments. For instance, friends may share photos, films, and music with each other, participants may share their briefings during a conference, teachers may share their teaching materials to students in a class. These applications are within the spirit of the present disclosure.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A remote play system, comprising:
at least a remote device; and
a master device wirelessly coupled to the remote device, the master device comprising a touch screen, wherein at least a remote device icon representing the remote device is displayed on a remote device display region of a browser panel of the touch screen, and at least a file icon representing a to-be-shared file is displayed on a file display region of the browser panel of the touch screen;
wherein,
in response to a drag-and-drop event triggered on the touch screen, the file icon is dragged and dropped to the remote device icon, and the master device shares the file to the remote device.

2. The remote play system according to claim 1, wherein,
a plurality of file icons representing a plurality of to-be-shared files are displayed on the file display region of the touch screen; and
the master device shares the files to the remote device in response to that the file icons are dragged and dropped to the remote device icon.

3. The remote play system according to claim 1, wherein,
a plurality of remote device icons representing a plurality of remote devices are displayed on the remote device display region of the touch screen; and
the master device share the file to the remote devices in response to that the file icon is dragged and dropped to the remote device icons.

4. The remote play system according to claim 1, wherein,
a plurality of file icons representing a plurality of to-be-shared files are displayed on the file display region of the touch screen;
a plurality of remote device icons representing a plurality of remote devices are displayed on the remote device display region of the touch screen; and
the master device shares the files to the remote devices in response to that the file icons are dragged and dropped to the remote device icons.

5. The remote play system according to claim 1, wherein,
at least an indicator icon is displayed on an indicating region of the browser panel of the touch screen, and one of the indicator icons represents the browser panel; and
an exit icon is displayed on an exit region of the browser panel of the touch screen, and in response to that the exit icon is touched, the browser panel is exited.

6. The remote play system according to claim 1, wherein,
when the master device shares the file to the remote device, the remote device display icon corresponding to the remote device displays a file play progress of the remote device.

7. The remote play system according to claim 1, wherein,
the remote device display icon selectively comprises a mode display icon;
the mode display icon displays an accept mode of the remote device; and
the accept mode of the remote device comprises at least four modes: a prompt mode, an accept once mode, an accept all mode and a block mode.

8. The remote play system according to claim 1, wherein,
a control panel is displayed on the touch screen of the master device during file sharing, and one of the browser panel and the control panel is displayed on the touch screen but the other one is not displayed;
the control panel comprises the remote device display region of the browser panel, the file display region of the browser panel, a playlist region, a play region, an exit icon and an indicating region;
the shared file is displayed on the playlist region;
a file play situation is displayed on the play region;
a plurality of indicator icons representing the browser panel and the control panel respectively are displayed on the indicating region of the control panel; and
the browser panel and the control panel are switched on the touch screen in response to a screen switch event.

9. The remote play system according to claim 8, wherein, the master device concurrently generates a plurality of control panels, and in the indicator icons displayed on the indicating region, the indicator icons corresponding to the control panels are of different colors.

10. The remote play system according to claim 1, wherein,
when the master device shares to the single remote device, the master device and the single remote device feed back their play progress to each other and the master device and the single remote device are synchronized on file playing.

11. The remote play system according to claim 1, wherein,
when the master device shares to a plurality of remote devices, a control operation on the master device controls all remote devices, but control operations on the remote devices does not control the master device.
